(19) United States
(12) Patent Application Publication
(10) Pub. No.: US 2008/0016200 A1
(43) Pub. Date: Jan. 17, 2008

(54) COMPUTER SYSTEM, MANAGEMENT COMPUTER, AND COMPUTER SELECTING METHOD

(75) Inventor: Koichi FUKUMI, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 11/777,003

(22) Filed: Jul. 12, 2007

(30) Foreign Application Priority Data
Jul. 14, 2006 (JP) 2006193531

(51) Int. Cl. G06F 15/173

(52) U.S. Cl. 709/223

(57) ABSTRACT

A computer system includes a management computer; and a spare computer group connected to the management computer. The management computer includes a data collecting module configured to collect hardware data of hardware configuration of at least one spare computer of the spare computer group; and a selecting module configured to select the spare computer which includes a predetermined hardware configuration, as an additional computer based on the hardware data.

### TECHNICAL FIELD

The present invention relates to a computer system. The present invention particularly relates to a technique to distribute a disk image to a computer which is newly added to an operation system in the computer system.

### BACKGROUND ART

There is known a server system which provides various kinds of services via a network. The server system is composed of a plurality of servers. If a load is increased by the increase in the number of users, a new server is added to an operation system to improve a processing capability, as described in Japanese Laid Open Patent Application (JP-P2006-11860A).

The server system is provided with a group of spare servers in advance for a request to add a server. When a server is added, it is considered to select one server from the group of spare servers and to install a necessary OS (Operating system) and software in a selected spare server. However, an installing process requires a prolonged time, so that a disk image of a distribution server is generally distributed to a selected spare server.

FIG. 1 is a flowchart showing a method of adding a server in a related arts. First, a disk image of a server in an operation state is prepared in advance (step S101). The disk image includes an OS, a middleware, and applications, being referred to as a “distribution source image” hereinafter. Subsequently, spare servers are registered in a management server (step S102). Thereafter, when an allocation of an additional server is requested (step S103), the management server selects an arbitrary spare server from a group of registered spare servers (step S104). The management server then copies a distribution source image to a disk of a selected spare server (step S105). When the copy is completed, a process of starting the selected spare server is performed (step S106). Here, there is a case where a hardware configuration (referred to as an “HW configuration” hereinafter) is different between the server in the operation state (distribution server) and the spare server. The HW configuration includes a type and slot insertion position of a board and the number of boards. In this case, since a device file name of storage unit is different, a portion of the distribution source image (OS, middleware, and applications) which refers to the device file name cannot be started normally. In case of a start failure (step S107; No), steps S104 to S106 are repeated for the remaining spare servers.

In Japanese Laid Open Patent Application (JP-P2000-207237A) is disclosed a technique to prevent a time loss in switching a system and an error in a switching operation in a duplex computer system. According to the technique a built-in circuit of a first computer (operation system) collects hardware configuration data thereof at the time of starting. A built-in circuit of a second computer (standby system) also collects hardware configuration data thereof at the time of starting. In switching a system, the hardware configuration data are compared from each other.

As described above, if an HW configuration is different between the distribution server and the spare server, a portion of a distribution source image which refers to the device file name cannot be started normally. In case of the start failure (step S107; No), steps S104 to S106 are repeated with respect to the remaining servers. This increases a period of time required to process a server addition.

The technique described in Japanese Laid Open Patent Application (JP-P2000-207237A) is a technique applicable to a duplex computer system, but impossible to be applied to the above-described case in which the spare server is newly added into the operation system. In particular, it is impossible to select an appropriate spare server to be added into operation from a group of spare servers.

In conjunction with the above description, a method of selecting a spare processor apparatus is disclosed in Japanese Laid Open Patent Application (JP-A-Heisei 7-121395). In this related art, a spare processor apparatus is incorporated in a computer system when a processor apparatus is failed. In this case, a type of software loaded on a memory of the failed processor apparatus is detected and a spare processor apparatus in which the same software as the detected software has been loaded on its memory in advance is selected with priority.

### SUMMARY

An exemplary object of the present invention is to provide a server system having a management computer, in which a new server can be added in a shorter time. Thus, when a now computer is added to an operation system, a time until the computer to be added can operate normally can be shortened, since a start error of the computer to be added can be prevented in advance.

In an exemplary aspect of the present invention, a computer system includes a management computer; and a spare computer group connected to the management computer. The management computer includes data collecting module configured to collect hardware data of hardware configuration of at least one spare computer of the spare computer group; and a selecting module configured to select the spare computer which includes a predetermined hardware configuration, as an additional computer based on the hardware data.

In an exemplary aspect of the present invention, a management computer includes a data collecting module configured to collect hardware data of hardware configuration of at least one spare computer of a spare computer group; and a selecting module configured to select the spare computer which includes a predetermined hardware configuration, as an additional computer based on the hardware data.

In an exemplary aspect of the present invention, a method of selecting a computer as a distribution destination of a disk image, includes collecting hardware data of a hardware configuration from at least one spare computer; and selecting a spare computer which includes a predetermined hardware configuration, based on the hardware data.

In an exemplary aspect of the present invention, a computer-readable software product for realizing a method of selecting a computer which includes collecting hardware data of a hardware configuration from at least one spare computer; and selecting a spare computer which includes a predetermined hardware configuration, based on the hardware data.

In this way, according to the present invention, a spare computer having a predetermined hardware configuration is selected. For example, the predetermined hardware configuration includes a hardware configuration of a distribution computer in the operation state. In this case, since the selected spare computer contains the hardware configuration of the distribution computer, it is guaranteed that the selected spare computer can start normally based on a disk image of the distribution computer. It is possible to prevent a situation that a portion of the disk image in which a device file name is referred cannot be started. That is, according to the present invention, a start error of a computer to be added can be prevented in advance before a copy of the disk image.

### BRIEF DESCRIPTION OF THE DRAWINGS

The above and other objects, advantages and features of the present invention will be more apparent from the following description of exemplary embodiments taken in conjunction with the accompanying drawings, in which:

FIG. 1 is a flowchart showing a method of distributing a distribution source image according to a conventional technique;

FIG. 2 is a block diagram showing a configuration of a server system according to the present invention;

FIG. 3 is a flowchart showing a method of distributing a distribution source image according to the present invention;

FIG. 4 is a diagram to explain an effect of the present invention;

FIG. 5 is a block diagram showing a configuration of the server system according to a first exemplary embodiment of the present invention;

FIG. 6 is a flowchart showing a method of selecting a spare server in the first exemplary embodiment;

FIG. 7 is a diagram showing an example of standardized HW data;

FIG. 8 is a block diagram showing a configuration of the server system according to a second exemplary embodiment of the present invention;

FIG. 9 is a diagram showing an example of an OS-PG link table in the second exemplary embodiment;

FIG. 10 is a flowchart showing a method of selecting the spare server in the second exemplary embodiment;

FIG. 11 is a block diagram showing a configuration of the server system according to a third exemplary embodiment of the present invention;

FIG. 12 is a diagram showing an example of an OS-HW link table in the third exemplary embodiment;

FIG. 13 is a diagram showing an example of a BPG-HW link table in the third exemplary embodiment; and

FIG. 14 is a flowchart showing a method of selecting the spare server in the third exemplary embodiment.

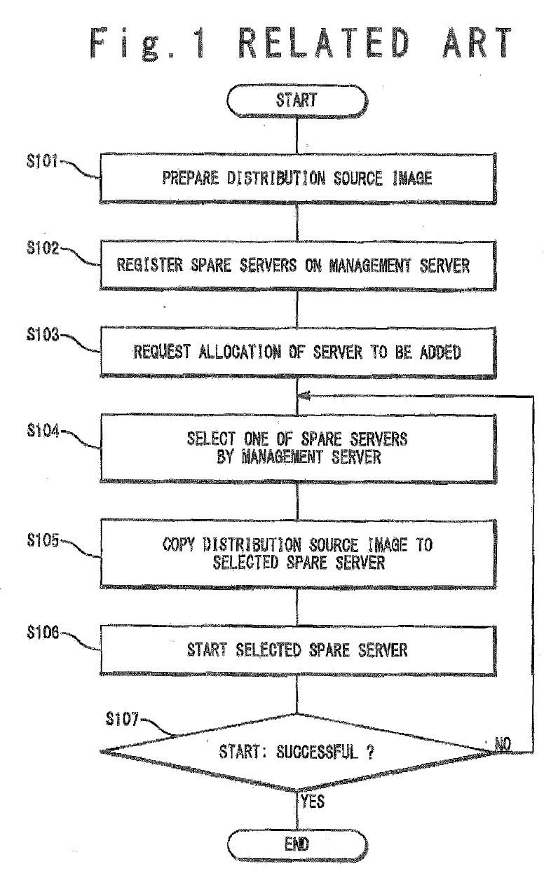

### EXEMPLARY EMBODIMENTS

Hereinafter, distribution of a source image by a computer system according to exemplary embodiments of the present invention will be described in detail with reference to accompanied drawings. The computer system exemplifies an autonomous computer system, a utility computer system, a grid system, and a virtual system. Also, a server system is exemplified as the computer system to provide various kinds of services.

### [Outline]

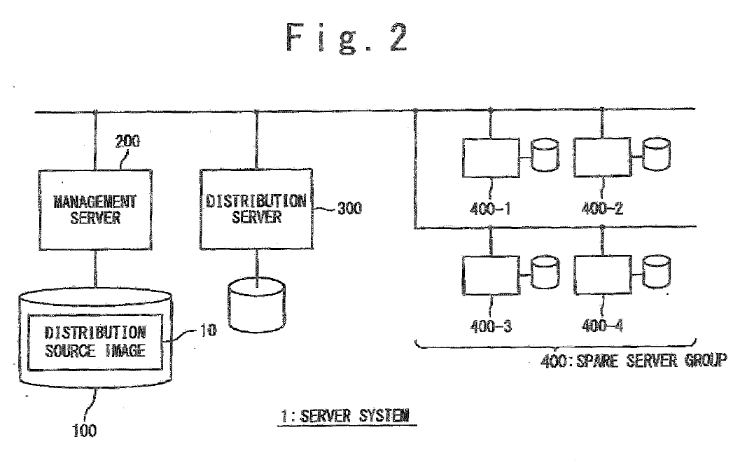

First, an outline of the present invention will be described. FIG. 2 is a block diagram showing a configuration of a server system 1 according to a first exemplary embodiment of the present invention. The server system 1 is provided with a group of servers connected from each other via a network such as a LAN (local area network). The group of servers includes a management server 200, a distribution server 300, and a group of spare servers 400. The management server 200 is a server to manage the entire servers. The distribution server 300 is a server in an operation state. The group of spare servers 400 includes at least one spare server. In FIG. 2, spare servers 400-1 through 400-4 are shown as an example. Each of the spare servers is a server which is changed from a standby state into the operation state if necessary. The server system 1 is also provided with a storage unit 100 which is accessible by the management server 200. For example, the storage unit 100 is a hard disk unit which is directly connected to the management server 200. Alternatively, the storage unit 100 may be connected to the management server 200 via an SAN (storage area network). When the spare server is changed into the operation state, a distribution source image 10 of the distribution server 300 in the operation state is distributed to the spare server. The distribution source image 10 is a disk image of the distribution server 300, including an OS, middleware, and applications. The distribution source image 10 has been stored in the storage unit 100 in advance.

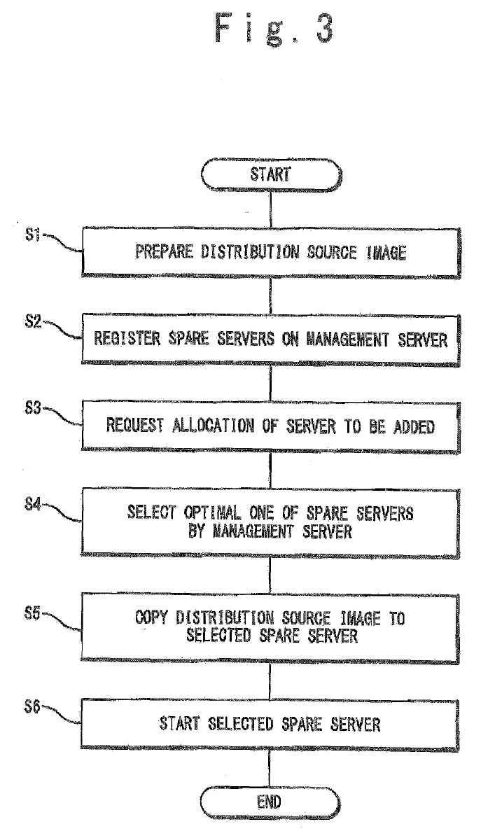

FIG. 3 is a flowchart showing a method of adding a server according to the present invention. First, the management server 200 prepares a distribution source image 10 of the distribution server 300 in the operation state, and stores the distribution source image 10 in the storage unit 100 (step S1). Subsequently, a user registers the group of the spare servers 400 in the management server 200 (step S2). Specifically, a name, model number, and installation site or the like of each spare server are registered in a predetermined file in the management server 200. Then, a user or load monitoring software requests the management server 200 to allocate an additional server (step S3). In response to the request, the management server 200 selects one optimal spare server from the registered group of the spare servers 400 (step 54). At this time, the management server 200 selects an optimal spare server, in consideration of the distribution server 300 and the registered group of the spare servers 400 in hardware configuration (HW configuration). The HW configuration of the optimal spare server to be selected includes the HW configuration of the distribution server 300. The HW configuration is data including a type of each of boards, the number of boards and a slot insertion position of each of the boards. The board includes an HBA (host bus adaptor) boards an SCSI (small computer system interface) board, and a LAN (local area network) board. A method of selecting an optimal spare server will be described later.

Next, the management server 200 copies the distribution source image 10 into a disk of the selected optimal spare server (step S5). When the copy is completed, the management server 200 starts the optimal spare server by utilizing a WOL (wake-on LAN) function (Step S6). According to the present invention, the HW configuration of the optimal spare server includes the HW configuration of the distribution server 300, so that the optimal spare server is started normally based on a replica of the distribution source image 10. It is possible to prevent a situation in which a portion, referring to a device file name, of the distribution source image 10 does not start.

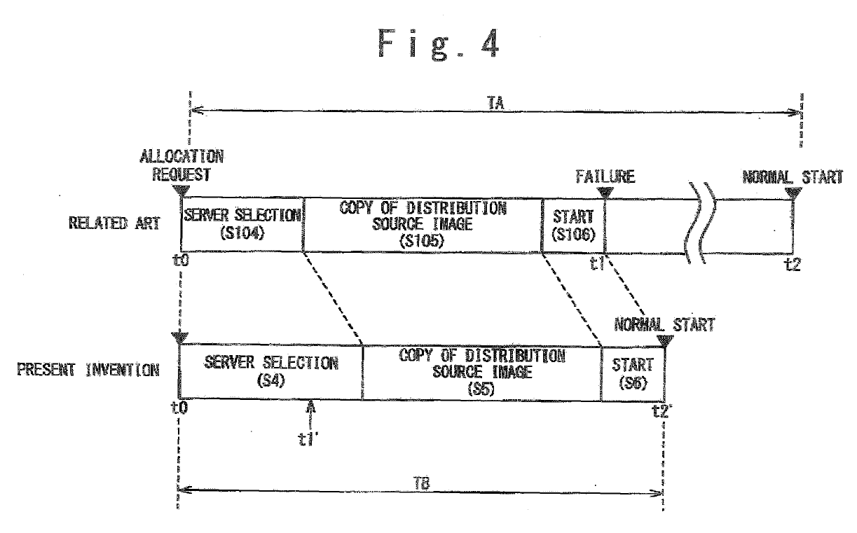

FIG. 4 shows comparison between the above related art technique and the present invention. According to the related art, an allocation request at time t0 is followed by execution of a server selection (step S104), a copy (step S105), and a start (step S106) in this order. Then, at time t1 in step S106, generation of a failure is finally detected. Meanwhile, according to the present invention, at time t1′ at which a server is being selected (step S4), an inappropriate spare server as a distribution destination of the distribution source image 10 can be detected. That is, before the distribution source image 10 is copied, it is made possible to prevent a failure of starting the additional server in advance.

In step S4, an optimal spare server is selected as a distribution destination of the distribution source image 10. As a result, at time t2′ in step S6, the additional server starts normally. It is possible to prevent a situation in which the OS, the middleware and the application do not start immediately after distributing the distribution source image due to a difference in the HW configuration. Since it is not necessary to retry a distribution process, a period TB from an allocation request to a normal start (time t0 to t2′) is shortened in comparison, with a period TA (time t0 to t2) according to the related art.

As described above, according to the present invention, it is made possible to prevent the failure of starting the additional server in advance when a new server is added to the server system 1. As a result, a period of time before starting the additional server normally is shortened.

Details of selecting the optimal spare server according to the present invention will be described below.

### First Exemplary Embodiment

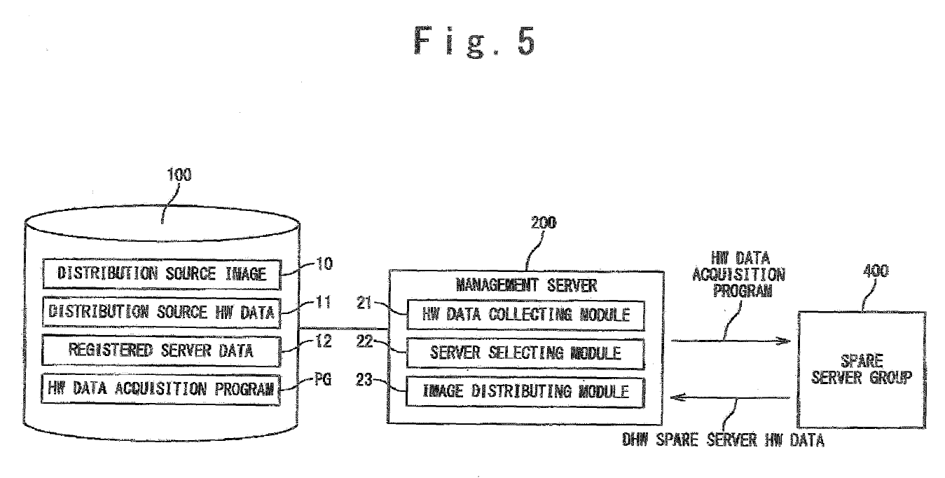

FIG. 5 is a block diagram showing a configuration of the server system 1 according to a first exemplary embodiment. In FIG. 5, the storage unit 100, the management server 200, and the group of the spare servers 400 are extracted and shown in particular.

The storage unit 100 stores the distribution source image 10, distribution course HW data 11, registered server data 12, and an HW data acquisition program PG. The distribution source image 10 is prepared by the management server 200 in the above-described step S1. The distribution source HW data 11 is hardware data (HW data) which indicates the HW configuration of the distribution server 300. That is, the distribution source HW data 11 indicates a type and slot position of a board and the number of the boards in the distribution server 300. The distribution source HW data 11 is prepared by the management server 200 in the above-described step S1. The registered server data 12 indicates data on servers which have been registered in the management server 200. More specifically, the registered server data 12 indicates a name, model number, installation site, and OS type/version of each of the registered servers. Data related to the group of the spare servers 400 is added to the registered server data 12 in the above-described step S2. Data on the distribution server 300 in the operation state has been already described in the registered server data 12. The HW data acquisition program PG is a program to acquire HW data of spare servers included in the group of the spare servers 400. The HW data acquisition program PG includes minimum software required to start the server and collect the HW data. The HW data acquisition program PG according to the resent exemplary embodiment is particularly configured so as to allow recognition of an HW configuration supported by the OS of the distribution server 300 at least. Although an I/O (input-output) driver required to acquire a device file name of a storage unit is incorporated, a command library is not necessary. The HW data which indicate HW configurations of the spare servers are referred to as “spare server HW data DHW” hereinafter.

The management server 200 has an HW data collecting module 21, a server selecting module 22, and an image distributing module 23. The HW data collecting module 21 collects the spare server HW data DHW by using the HW data acquisition program PG in the above-described step S4. The HW data collecting module 21 can also acquire the distribution source HW data 11. The server selecting module 22 selects the optimal spare server on the basis of the spare server HW data DHW in the above-described step S4. The image distributing module 23 copies the distribution source image 10 into a disk of the optimal spare server in the above described step S5. These modules 21, 22 and 23 are provided through cooperation between software and an operation processing unit.

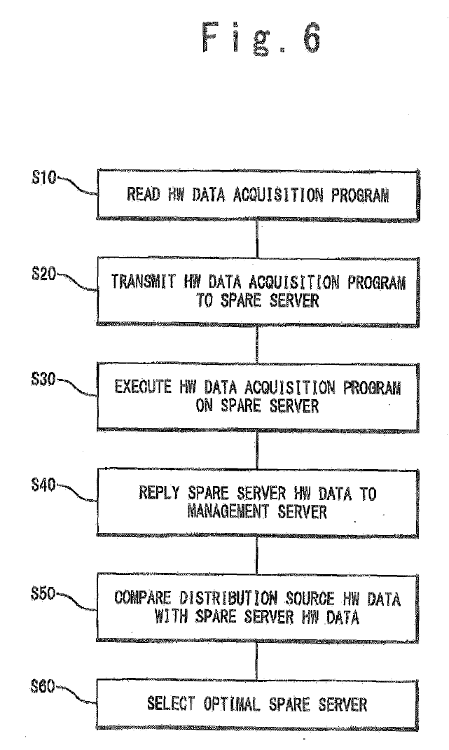

FIG. 6 is a flowchart showing the details of the above-described step S4 (selection of an optimal spare server). Referring to FIGS. 5 and 6, the details of step S4 will be described.

### Step S10:

In response to a request to allocate an additional server, the management server 200 determines the HW data acquisition program PG. In the present exemplary embodiment, the management server 200 reads out the HW data acquisition program PG from the storage unit 100.

### Step S20:

The management server 200 instructs the spare servers to start by utilizing a WOL (wake-on LAN) function. Along with a start instruction by the WOL function, the HW data collecting module 21 can send the HW data acquisition program PG to the group of the spare servers 400. For examples the HW data collecting module 21 collectively transmits the HW data acquisition program PG to entire spare servers included in the group of the spare servers 400. Alternatively, the HW data collecting module 21 may also transmit the HW data acquisition program PG to a part of the group of spare servers exclusively. The HW data collecting module 21 nay also transmit the HW data acquisition program PG to spare servers one by one sequentially.

The HW data acquisition program PG is stored in an RAM (random access memory) of each spare server. Software which is necessary to start the server is incorporated in the HW data acquisition program PG as described above, so that the management server 200 instructs each spare server to start by utilizing the software. Each spare server is started by utilizing software included in the HW data acquisition program PG.

### Step S30:

A started spare server executes the received HW data acquisition program PG. The HW data acquisition program PG checks the HW configuration of the spare server in order to acquire the spare server HW data DHW. As described above, drivers for recognizing the HW configuration supported by the OS of the distribution server 300 are incorporated in the HW data acquisition program PG. Each driver issues a command to corresponding hardware, and receives a response from the hardware. The response includes HW data related to the hardware. HW data obtained by the drivers are integrated to form the spare server HW data DHW which indicate the HW configurations of the spare servers.

### Step S40:

The HW data acquisition program PG sends the obtained spare server HW data DHW as a reply to the management server 200. The spare server HW data DHW includes HW data and ID of the spare server. After the reply, each spare server is suspended. The HW data collecting module 21 collects the spare server HW data DHW related to each spare server.

### Step S50:

Next, the server selecting module 22 compares the spare server HW data DHW of the group of the spare servers 400 with the distribution source HW data 11 stored in the storage unit 100. There is a possibility that data unique to the OS is mixed in the HW data. In order to realize a general-purpose comparing process, the server selecting module 22 has a function to convert (standardize) HW data into a certain format.

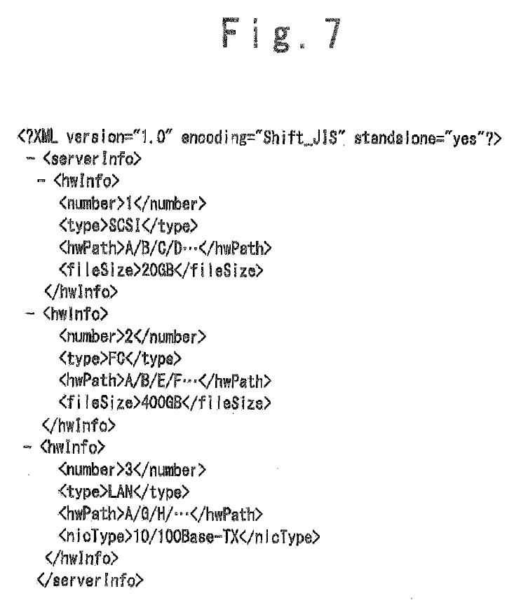

FIG. 7 shows an example of standardized HW data. In FIG. 7, the HW data is standardized in an XML (extensible markup language) format. An item <number> indicates a slot position. An item <type> indicates a type of hardware. An item <hwPath> indicates a path of hardware. Items <fileSize> and <nicType> indicate option data.

### Step S60:

The server selecting module 22 selects one optimal spare server from the group of the spare servers 400 by comparing the standardized HW data. It is not necessary here that the HW configuration of the optimal spare server is completely consistent with the HW configuration of the distribution server 300, but the HW configuration of the distribution server 300 should be included. That is, the server selecting module 22 selects a spare server which includes the HW configuration of the distribution server 300 as the optimal spare server. For example, in HW data shown in FIG. 7, a slot position and a path related to each of portions of the HW configuration of the distribution server 300 need to be consistent with those related to the optimal spare server. However, it is not necessary that entire HW configuration of the optimal spare server is included in the distribution server 300. Moreover, a value indicated by <fileSize> in the distribution server 300 needs to be equal to or lower than a corresponding value in the optimal spare server.

The server selecting module 22 selects the optimal spare server on the basis of the spare server HW data DHW and the distribution source HW date 11. The selected optimal spare server has the same HW configuration as the distribution server 300 at least. If a plurality of candidates exist, the server selecting module 22 selects either of the candidates as the optimal spare server.

### Second Exemplary Embodiment

Next, the selection of the optimal spare server in a second exemplary embodiment of the present invention will be described. In the second exemplary embodiment, the same components as components shown in the first exemplary embodiment are allocated with the same reference numerals and the same description will be appropriately omitted.

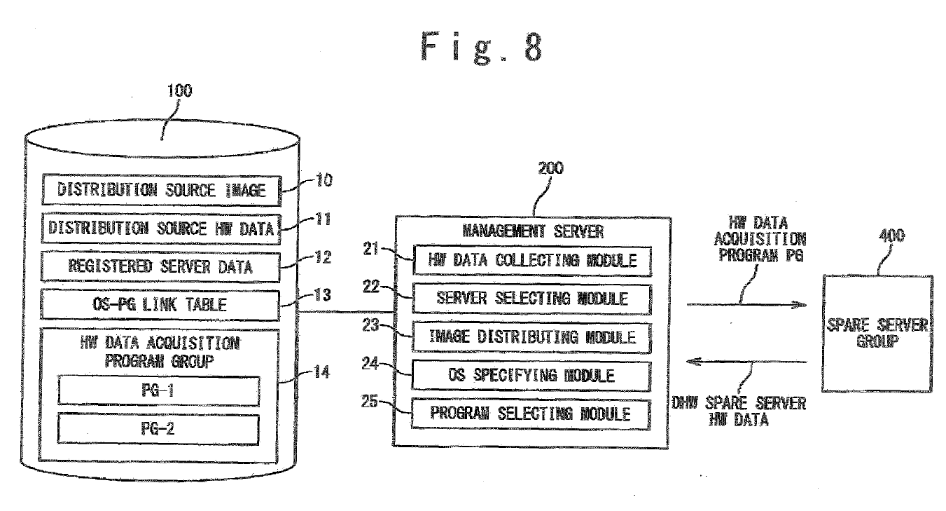

FIG. 8 is a block diagram showing a configuration of the server system 1 according to the second exemplary embodiment. In comparison with the first exemplary embodiment, the storage unit 100 in further stores an OS-PG link table 13 and a group of HW data acquisition programs 14. Moreover, the management server 200 further has an OS specifying module 24 and a program selecting module 25. These modules 24 and 25 are also provided through cooperation of the software and the operation processing unit.

A supported HW configuration is different depending on the OS type of the distribution server 300 in the operation state. Accordingly, it is possible to prepare the HW data acquisition program PG which is exclusively programmed to every OS type in advance. The group of the HW data acquisition programs 14 is a group of the exclusive five HW data acquisition programs PG as described above. That is, the group of the HW data acquisition programs 14 is composed of a plurality of HW data acquisition programs PG-1, PG-2, . . . that are made to correspond to a plurality of OS types, respectively. Each of the HW data acquisition programs is sufficient to recognize an HW configuration supported by a corresponding OS at least.

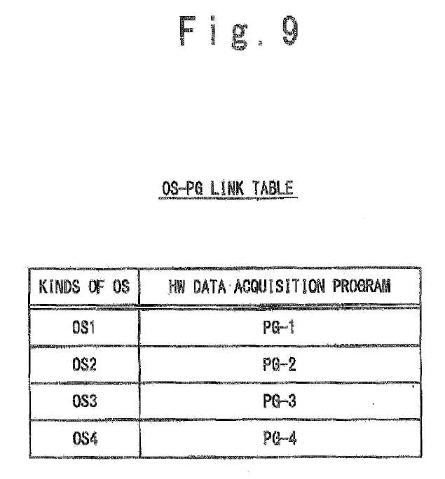

The OS-PG link table 13 is a table which indicates relationship between the plurality of OS types and a plurality of the HW data acquisition programs. FIG. 9 shows an example of the OS-PG link table 13. In FIG. 9, OS types including OS1 to OS4 are made to correspond to the HW data acquisition programs including PG-1 to PG-4, respectively. The OS types having mutually different versions may also be treated as different OS types.

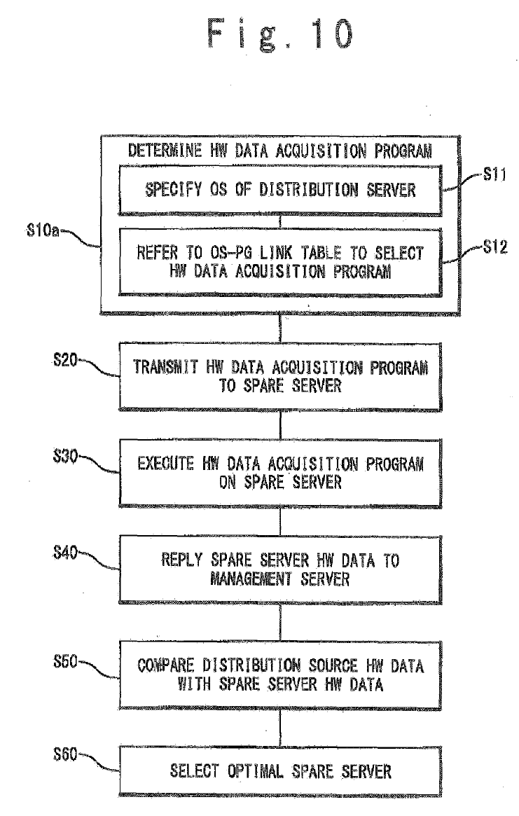

FIG. 10 is a flowchart showing details of step S4 (selection of an optimal spare server) in the second exemplary embodiment. Referring to FIGS. 8 to 10, the details of step S4 will be described,

### Step S10a:

In response to a request to allocate the additional server, the management server 200 determines the HW data acquisition program PG. More specifically, the OS specifying module 24 initially refers to the registered server data 12 in the storage unit 100 in order to specify an OS used by the distribution source sever 300 (step S11). Next, the program selecting module 25 refers to the above-described OS-PG link table 13 in order to select one program which was made to correspond to a specified OS from the group of the HW data acquisition programs 14 (step S12). The selected one program is used as the HW data acquisition program PG in the second exemplary embodiment. For example, the OS specifying module 24 detects that the type of an OS of the distribution server 300 is “OS1”. The program selecting module 25 then selects the program PG-1 as the HW data acquisition program PG by referring to the OS-PG link table 13 shown in FIG. 9. The selected HW date acquisition program PG can recognize an HW configuration supported by the OS1 at least.

Steps S20 to S60 thereafter remain the same with those of the first exemplary embodiment. According to the second exemplary embodiment, the HW data acquisition program which has been transmitted to the group of the spare servers 400 in step S20 is not required to recognize entire HW configuration supported by the plurality of types of the OS. Each of the HW data acquisition programs PG-1, PG-2 . . . have only to recognize only an HW configuration supported by one kind of the corresponding OS. Accordingly, a size of each HW data acquisition program is reduced, and a period of time to process transmission is shortened. A reduction is also realized in a size of the HW data acquisition program PG executed by each spare server in step 30. Accordingly, a load is reduced and a period of time to acquire the HW data is shortened.

### Third Exemplary Embodiment

Next, the selection of the optimal spare server in a third exemplary embodiment will be described. In the third exemplary embodiment, the same components as the components shown in the first and second exemplary embodiments are allocated with the same reference numerals, and the same description will be appropriately omitted.

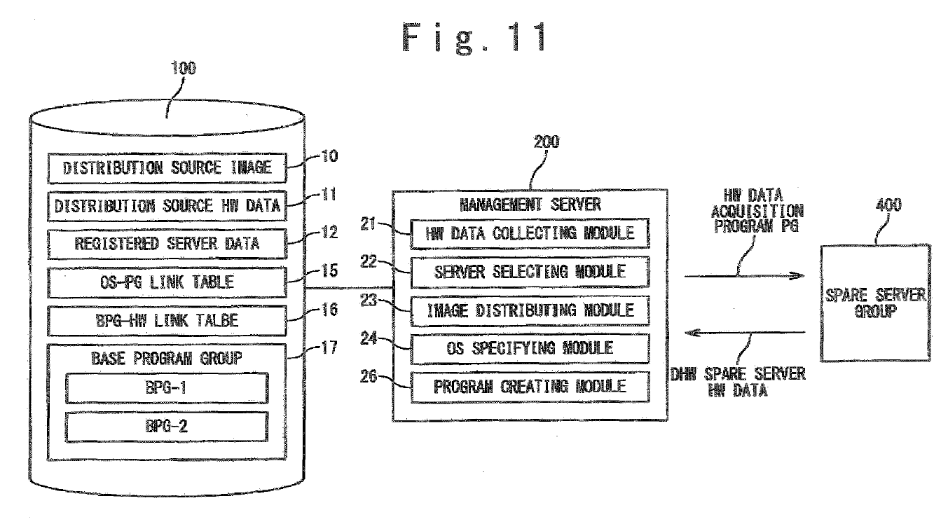

FIG. 11 is a block diagram showing the configuration or the server system 1 according to the third exemplary embodiment of the present invention. In comparison with the first exemplary embodiment, the storage unit 100 further stores an OS-HW link table 15, a BPG-HW link table 16, and a group of base programs 17. Moreover, the management server 200 further has the OS specifying module 24 and a program creating module 26. These modules 24 and 26 are also provided through cooperation of the software and the operation processing unit.

The HW data acquisition program PG which has been exclusively programmed to every OS type is provided in the second exemplary embodiment. There are common portion existing between these exclusive HW data acquisition programs PG. A disk space can be effectively utilized by sharing the common portions. Therefore, according to the third exemplary embodiment, a base program BPG which can recognize a predetermined HW configuration is prepared. A combination of a plurality of the base programs BPG allows creation of the HW data acquisition program PG which can recognize an HW configuration supported by a specified OS. The group of the base programs 17 is a group of the base programs BPG as described above. That is, the group of the base programs 17 is composed of a plurality of base programs BP-1, BPG-2 . . . .

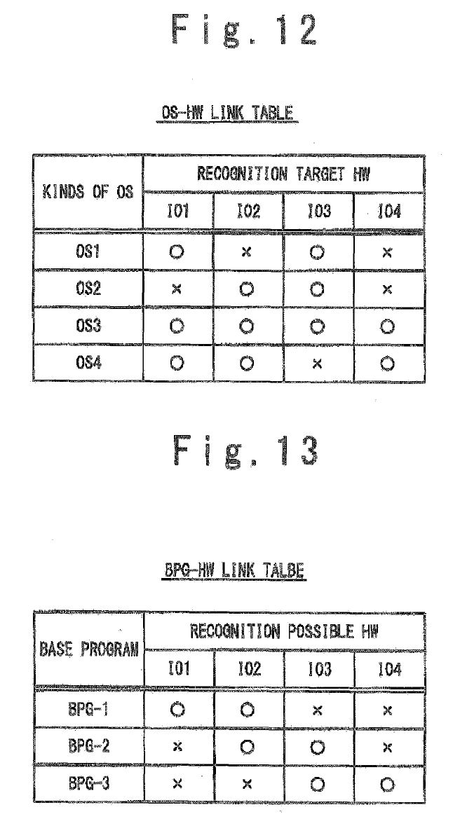

The OS-HW link table 15 is a table which indicates an HW configuration supported by each of the plurality of types of the OS. FIG. 12 shows an example of the OS-HW link table 15. In FIG. 12, there is shown relationship between the OS types including OS1 to OS4 and HW configuration types including IO1 to IO4. In FIG. 12, a white circle means that an HW configuration thereof is supported. For example, if the OS type is OS1, IO1 and IO3 are supported as the HW configuration. In other words, if the OS type is OS1, it is understood that IO1 and IO3 are an object to recognized. The OS types with mutually different versions may also be treated as different OS types.

The BPG-HW link table 16 is a table which indicates an HW configuration recognizable by each of the plurality of the base programs BPG. FIG. 13 shows an example of the BPG-HW link table 16. In FIG. 13, there is shown a relationship between base program types BPG-1 to BPG-3 and the recognizable HW configuration types IO1 to IO4. In FIG. 13, a white circle means that the HW configuration thereof is recognizable. For example, it could be understood that the base program BPG-1 can recognize IO1 and IO2.

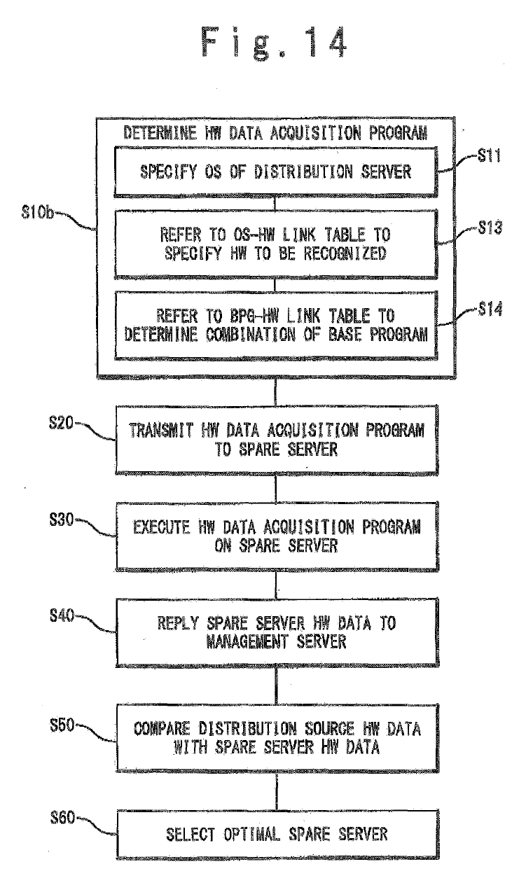

FIG. 14 is a flowchart showing the details of step 4 (selection of an optimal spare server) in the third exemplary embodiment. Referring to FIGS. 11 to 14, the details of step S4 will be described.

### Step S10b:

In response to a request to allocate the additional server, the management server 200 determines the HW data acquisition program PG. More specifically, the OS specifying module 24 initially refers to the registered server data 12 in order to specify an OS used by the distribution server 300 (step S11). Subsequently, the program creating module 26 refers to the above-described OS-HW link table 15 to detect the HW configuration supported by the specified OS. That is, the program creating module 26 specifies an HW configuration which should to be recognized (step S13). Subsequently, the program creating module 26 refers to the above-described BPG-HW link table 16 to determine a combination of the base programs BPG capable of recognizing the HW configuration which should to be recognized. The program creating module 26 then reads the base programs BPT corresponding to a determined combination from the group of the base programs 17 to create the HW data acquisition program PG (step S14). For example, the OS specifying module 24 detects that the OS type of the distribution server 300 is OS4. The program creating module 26 then refers to the OS-HW link table 15 shown in FIG. 12 to specify IO1, IO2 and IO4 as objects to be recognized. Furthermore, the program creating module 26 refers to the BPG-HW link table 16 shown in FIG. 13 to create the HW data acquisition program PG by combining the base programs BPG-1 and BPG-3. The created HW data acquisition program PG can recognize IO1, IO2 and IO4 at least.

Steps S20 to S60 thereafter are same as those of the first exemplary embodiment. According to the third exemplary embodiment, effects similar to those of the second exemplary embodiment can be obtained. Furthermore, the HW data acquisition program PG is created from the group of the base programs 17 in accordance with the OS type, so that it is not necessary to prepare the HW data acquisition program PG for every OS types. Sharing a common program portion allows a reduction in the disk space. Maintenance costs of a disk and program can also be reduced.

Instead of using the OS specifying module 24 and the OS-HW link table 15, the program creating module 26 may directly specify an HW configuration of an object to recognize from the distribution source image 10.

According to the present invention, it is made possible to prevent a failure to start an additional computer beforehand in adding a new computer into operation in a computer system. As a result, a period of time before starting the additional computer normally is shortened.

Although the present invention has been described above in connection with several exemplary embodiments thereof, it would be apparent by those skilled in the art that those exemplary embodiments are provided solely for illustrating the present invention, and should not be relied upon to construe the appended claims in a limiting sense.

What is claimed is:

1. A computer system comprising:
a management computer; and
a spare computer group connected to said management computer,
said management computer comprises:
a data collecting module configured to collect hardware data of hardware configuration of at least one spare computer of the spare computer group; and
a selecting module configured to select said spare computer which includes a predetermined hardware configuration, as an additional computer based on said hardware data.

2. The computing system according to claim 1, wherein said data collecting module transmits an acquisition program to said spare computer and starts said spare computer such that said acquisition program is executed to transmit said hardware data of said spare computer to said management computer.

3. The computing system according to claim 2, further comprising:
a distribution computer in an operation state,
wherein said predetermined hardware configuration is a hardware configuration of said distribution computer.

4. The computing system according to claim 3, herein said selecting module compares said hardware data of said distribution computer and said hardware data of said spare computer and selects said select said additional computer.

5. The computing system according to claim 4, wherein said selecting module converts said hardware data into in a predetermined format, and compares said hardware data of said distribution computer after said conversion and said hardware data of said spare computer after said conversion.

6. The computing system according to claim 3, wherein said management computer further comprises:
a storage unit configured to store a plurality of programs respectively corresponding to a plurality of kinds of an operating system (OS),
an OS specifying module configured to specify a kind of said OS used in said distribution computer; and
a program selecting module configured to select one of said plurality of programs as said acquisition program based on the specified kind of said OS.

7. The computing system according to claim 6, wherein said storage unit further stores a table indicating relation between said plurality of programs and said plurality of types of said OS,
said program selection module refers to said able based on the type of said OS to determine said acquisition program.

8. The computing system according to claim 3, wherein said management computer further comprises:
a storage unit configured to store a plurality of base programs, each of which is used to recognize a specific hardware configuration portion;
an operating system (OS) specifying module configured to specify a kind of said OS used in said distribution computer; and
a program creating module configured to create said acquisition program by combining some of said plurality of bass programs to recognize the hardware structure portions supported by the specified kind of said OS.

9. The computing system according to claim 8, wherein said storage unit stores a first table indicating said hardware configuration supported by each of a plurality of types of said OS, and a second table indicating the hardware configuration portions recognizable by each of said plurality of base programs, and
said program creating module refers said first and second tables to determine the combination of said plurality of base programs.

10. The computing system according to claim 3, wherein said management computer further comprises:
an image distributing module configured to copy a disk imago of said distribution computer to said selected spare computer.

11. The computing system according to claim 2, wherein said spare computer group comprises spare computers, and
said data collecting module collectively transmits said acquisition program to all said spare computers.

12. The computing system according to claim 2, wherein said spare computer group comprises spare computers, and
said data collecting module selectively transmits said acquisition program to a part of said spare computers.

13. The computing system according to claim 1, wherein said hardware configuration contains a type and slot position of each of circuit boards and a number of the circuit boards.

14. A management computer comprising:
a data collecting module configured to collect hardware data of hardware configuration of at least one spare computer of a spare computer group; and
a selecting module configured to select said spare computer which includes a predetermined hardware configuration, as an additional computer based on said hardware data.

15. The management computer according to claim 14, wherein said data collecting module transmits an acquisition program to said spare computer and starts said spare computer such that said acquisition program is executed to transmit said hardware data of said spare computer to said management computer.

16. The management computer according to claim 14, wherein said predetermined hardware configuration is of a distribution computer in an operation state.

17. The management computer according to claim 14, wherein said selecting module compares said hardware data of said distribution computer and said hardware date of said spare computer and selects said select said additional computer.

18. The management computer according to claim 16, further comprising:
an image distributing module configured to copy a disk image of said distribution computer to said selected spare computer.

19. A method of selecting a computer as a distribution destination of a disk image, comprising:
collecting hardware data of a hardware configuration from at least one spare computer; and
selecting a spare computer which includes a predetermined hardware configuration, based on said hardware data.

20. The method according to claim 19, wherein and collecting comprises:
transmitting an acquisition program said spare computer; and
executing said acquisition program to transmitting said hardware data of said hardware configuration of said spare computer.

21. A computer-readable software product for realizing a method of selecting a computer which comprises:
collecting hardware data of a hardware configuration from at least one spare computer; and
selecting a spare computer which includes a predetermined hardware configuration, based on said hardware data.
